(19) United States
(12) Patent Application Publication
(10) Pub. No.: US 2011/0025793 A1
(43) Pub. Date: Feb. 3, 2011

(54) Inkjet head and method of manufacturing the same

(75) Inventors: Chang Sung Park, Grynggi-do (KR); Jae Woo Joung, Gyunggi-do (KR); Young Seuck Yoo, Seoul (KR); Won Chul Sim, Gyunggi-do (KR); Yoon Sok Park, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon (KR)

(21) Appl. No.: 12/654,242

(22) Filed: Dec. 15, 2009

(30) Foreign Application Priority Data
Jul. 28, 2009 (KR) 10-2009-0068823

(51) Int. Cl. B41J 2/19; G11B 5/127

(52) U.S. Cl. 347/92; 216/27

(57) ABSTRACT

An inkjet head according to an aspect of the invention may include: a flow path plate having a plurality of ink chambers therein; a nozzle plate having a plurality of nozzles connected to the ink chambers in order to eject ink in the ink chambers to the outside; and air traps provided inside the flow path plate and the nozzle plate to prevent crosstalk in which vibrations for driving the ink chambers affect another adjacent ink chamber.

### CROSS-REFERENCE TO RELATED APPLICATIONS

This application claims the priority of Korean Patent Application No. 10-2009-0068823 filed on Jul. 28, 2009, in the Korean Intellectual Property Office, the disclosure of which is incorporated herein by reference.

### BACKGROUND OF THE INVENTION

1. Field of the Invention

The present invention relates to an inkjet head and a method of manufacturing the same, and more particularly, to an inkjet head that can increase printing quality and a method of manufacturing the same.

2. Description of the Related Art

In general, an inkjet head converts an electric signal into a physical force so that ink droplets are ejected through small nozzles.

In recent years, piezoelectric inkjet heads have been used in industrial inkjet printers. For example, a circuit pattern is directly formed by spraying ink prepared by melting metals such as gold or silver onto a printed circuit board (PCB). A piezoelectric inkjet head is also used for industrial graphics, and is used in the manufacturing of a liquid crystal display (LCD) and an organic light emitting diode (OLED).

In general, an inlet and an outlet through which ink is introduced and ejected in a cartridge, a reservoir storing the ink being introduced, and chambers through which a driving force of an actuator by which the ink in the reservoir is moved to nozzles are provided in an inkjet head of an inkjet printer.

However, in a case of an inkjet head according to the related art, vibrations from the actuator mounted around the chamber are transmitted to a chamber adjacently connected to the same upper plate as well as the chamber for ink ejection.

Therefore, this causes unstable meniscus in the inkjet head according to the related art, which results in unstable droplet ejection and serves as noise in the eigenfrequency of the chamber, thereby deteriorating printing quality.

### SUMMARY OF THE INVENTION

An aspect of the present invention provides an inkjet head and a method of manufacturing the same that can prevent crosstalk in which vibrations of an actuator affect another adjacent chamber.

According to an aspect of the present invention, there is provided an inkjet head including: a flow path plate having a plurality of ink chambers therein; a nozzle plate having a plurality of nozzles connected to the ink chambers in order to eject ink in the ink chambers to the outside; and air traps provided inside the flow path plate and the nozzle plate to prevent crosstalk in which vibrations for driving the ink chambers affect another adjacent ink chamber.

Open recesses may be provided in at least one of the flow path plate and the nozzle plate.

The recesses and the air traps may be connected to each other.

The open recesses may be provided in both ends of actuators provided on an upper surface of the flow path plate and corresponding to the ink chambers.

The air traps may be provided between one of the ink chambers and another ink chamber adjacent thereto.

The air traps may be provided between the ink chambers and an ink introduction hole through which ink is introduced.

The air traps may be provided between dampers ejecting the ink in the ink chamber through the nozzles and a manifold supplying ink to the ink chambers.

According to another aspect of the present invention, there is provided a method of manufacturing an inkjet head, the method including: providing a flow path plate and a nozzle plate; forming a plurality of recesses in one surface of the flow path plate and one surface of the nozzle plate making contact with each other; and forming air traps inside the flow path plate and the nozzle plate by bonding the flow path plate and the nozzle plate with the plurality of recesses.

The forming of the plurality of recesses may include forming open recesses in a surface of the flow path plate.

The plurality of recesses and the open recesses may be connected to each other.

The plurality of recesses may be formed at the same time by an etching process.

A multi-stage damper may be formed in the nozzle plate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an inkjet head according to an exemplary embodiment of the present invention;

FIG. 2 is a cross-sectional view illustrating the inkjet head of FIG. 1;

FIG. 3 is a side sectional view illustrating the inkjet head of FIG. 1;

FIG. 4 is a cross-sectional view illustrating a method of manufacturing an inkjet head according to an exemplary embodiment of the present invention;

FIG. 5 is a schematic perspective view illustrating an inkjet head according to another exemplary embodiment of the present invention;

FIG. 6 is a cross-sectional view illustrating the inkjet head of FIG. 5;

FIG. 7 is a side sectional view illustrating the inkjet head of FIG. 5; and

FIG. 8 is a schematic perspective view illustrating an inkjet head according to another exemplary embodiment of the present invention.

### DETAILED DESCRIPTION OF THE PREFERRED EMBODIMENT

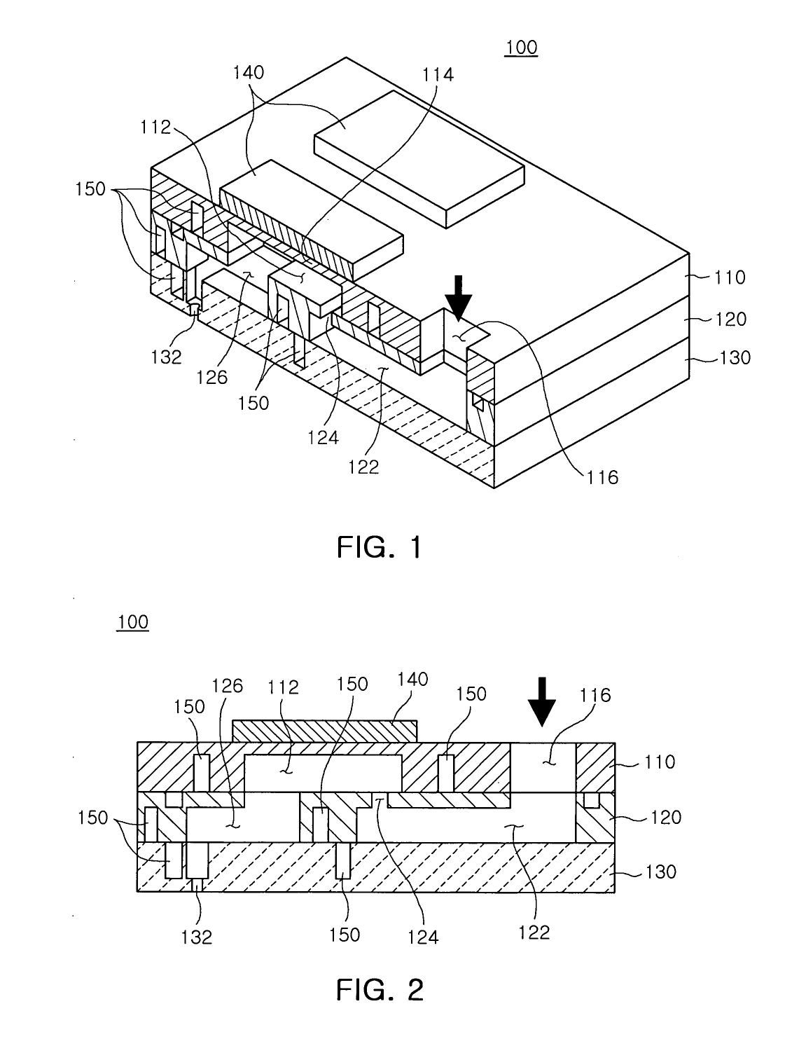

An inkjet head according to an exemplary embodiment of the invention will be described in detail with reference to FIGS. 1 through 8. Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

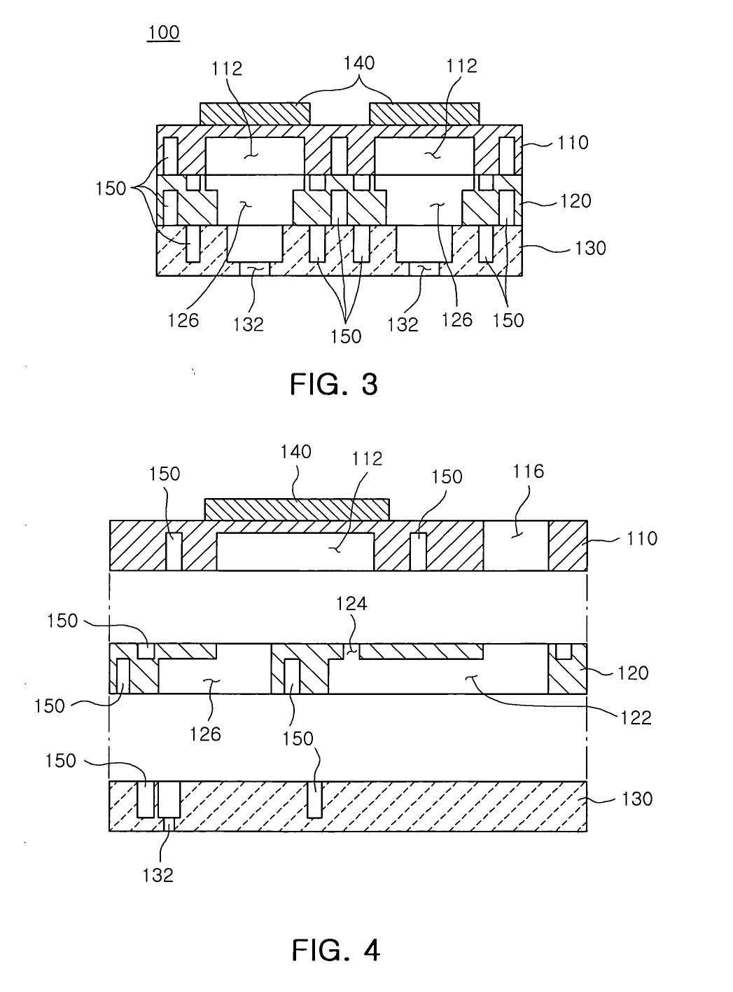

FIG. 1 is a schematic perspective view illustrating an inkjet head according to an exemplary embodiment of the invention. FIG. 2 is a cross-sectional view illustrating the inkjet head of FIG. 1. FIG. 3 is a side sectional view illustrating the inkjet head of FIG. 1.

Referring to FIG. 1, an inkjet head 100 includes a flow path plate 110, an intermediate plate 120, a nozzle plate 130 and air traps 150.

A plurality of ink chambers 112 are formed in the flow path plate 110. An ink introduction hole 116 is formed in the flow path plate 110, through which ink is introduced. Here, the ink introduction hole 116 is directly connected with a manifold 122. The manifold 122 supplies ink to the ink chambers 112 through a restrictor 124 (in the direction of the arrow).

Here, the manifold 122 may be one big space to which the plurality of ink chambers 112 are connected. However, the invention is not limited thereto. A plurality of manifolds 122 may be formed to correspond to the individual ink chambers 112.

Similarly, one ink introduction hole 116 may be formed to correspond to one manifold 122. When the plurality of manifolds 122 are formed, a plurality of ink introduction holes 116 may be formed to correspond to the individual manifolds 122.

Here, the air traps 150 may be formed between the ink chambers 112 and the ink introduction hole 116 of the flow path plate 110.

The ink chambers 112 are provided in the flow path plate 110 at positions located under piezoelectric actuators 140. Here, a portion of the flow path plate 110 that forms the ceiling of the ink chambers 112 serves as a vibration plate 114.

Therefore, when a driving signal is applied to the piezoelectric actuators 140 in order to eject ink, the piezoelectric actuators 140 and the vibration plate 114 thereunder are deformed to reduce the volumes of the ink chambers 112.

Here, the reduction in the volumes of the ink chambers 112 increases the pressure inside the ink chambers 112, so that ink inside the ink chambers 112 is ejected to the outside through dampers 126 and nozzles 132.

Electrodes electrically connected to each other may be formed on upper and lower surfaces of each of the piezoelectric actuators 140. The electrodes may be formed of Lead Zirconate Titanate (PZT) ceramics, which is one of piezoelectric materials.

Here, the above space together with the air traps 150 may be created in the flow path plate 110 by an etching process in order to form the ink chambers 112 and the ink introduction hole 116.

The intermediate plate 120 may include the manifold 122 having a large length extending in a longitudinal direction and the dampers 126 connecting the nozzles 132 and the ink chambers 112.

The manifold 122 is supplied with ink through the ink introduction hole 116 and supplies the ink to the ink chambers 112. The manifold 122 and the ink chambers 112 are connected with each other through the restrictor 124.

The dampers 126 receive the ink ejected from the ink chambers 112 through the piezoelectric actuators 140 and eject the received ink to the outside through the nozzles 132.

The dampers 126 may have a multi-stage configuration by which the amount of ink ejected from the ink chambers 112 and the amount of ink ejected through the nozzles 132 can be controlled.

Here, the dampers 126 are optional. When the dampers 126 are removed, the inkjet head only includes the flow path plate 110 and the nozzle plate 130.

The intermediate plate 120 may include the dampers 126 and the manifold 122 together with the plurality of air traps 150.

The nozzle plate 130 corresponds to the ink chambers 112 and includes the nozzles 132 through which the ink passing through the dampers 126 is ejected to the outside. The nozzle plate 130 is bonded to the bottom of the intermediate plate 120.

The ink moving through a flow path formed inside the inkjet head is sprayed as ink droplets through the nozzles 132.

Here, silicon substrates being widely used for semiconductor integrated circuits may be used as the flow path plate 110, the intermediate plate 120, and the nozzle plate 130.

The plurality of air traps 150 may be formed in the flow path plate 110, the intermediate plate 120, and the nozzle plate 130, thereby preventing crosstalk in which vibrations, generated to drive one ink chamber 112, affect neighboring ink chambers.

Specifically, as shown in FIG. 3, the air trap 150 may be located between one ink chamber 112 and its adjacent ink chamber 112.

As the vibration plate 114 is deformed by the piezoelectric actuators 14, the ink chambers 112 eject ink to the outside. Another ink chamber 112 may be affected by the vibrations caused by the piezoelectric actuators 140.

However, in this embodiment, since the air traps 150 are formed between the ink chambers 112 and its adjacent ink chambers 112, the transmission of vibrations can be prevented about halfway to another ink chamber.

Furthermore, the air traps 150 may be formed between the ink chambers 112 and the ink introduction hole 116 through which ink is introduced. Therefore, the air traps 150 can prevent the transmission of the vibrations caused by the piezoelectric actuators 140 to the ink introduction hole 116.

The air traps 150 may also be formed between the dampers 126 that eject the ink in the ink chambers 112 through the nozzles 132 and the manifold 122 that supplies the ink to the ink chambers 112. Therefore, the transmission of the vibrations caused by the piezoelectric actuators 140 to the manifold 122 or the nozzles 132 can be prevented.

The plurality of air traps 150 are not manufactured separately. As described above, however, after recesses corresponding to the air traps 150 are formed by an etching process together with other components, the flow path plate 110, the intermediate plate 120 and the nozzle plate 130 are bonded to each other to thereby form the air traps 150. Therefore, it is possible to manufacture the air traps 150 with ease. However, the locations of the air traps 150 are not limited thereto and may be designed in various manners according to the designers' intentions.

FIG. 4 is a cross-sectional view illustrating a method of manufacturing an inkjet head according to an exemplary embodiment of the invention.

Referring to FIG. 4, a method of manufacturing an inkjet head includes providing the flow path plate 110 and the nozzle plate 130.

In order to form the air traps 150, the ink chambers 112 are formed in one surface of the flow path plate 110 and a plurality of recesses are formed in the nozzle plate 130.

The plurality of recesses are formed by an etching process together with the ink chambers 112, the manifold 122, the dampers 126 and the nozzles 132.

The flow path plate 110 and the nozzle plate 130 are then bonded to each other to thereby form air traps 150 therein.

Here, the flow path plate 110, the intermediate plate 120 and the nozzle plate 130 are bonded to each other to form a single body. That is, the intermediate plate 120 is bonded to the bottom of the flow path plate 110, and the nozzle plate 130 is bonded to the bottom of the intermediate plate 120.

However, during the bonding process, air may become trapped within each layer, which is a frequent cause of bonding failures when manufacturing an inkjet head.

Therefore, in this embodiment, the trapped air is automatically moved to the space inside the air traps 150, thereby preventing the bonding failures caused by trapped air.

In addition, since the air traps 150 may be formed between the ink chambers 112 and the ink introduction hole 116 through which ink is introduced, the transmission of the vibrations caused by the piezoelectric actuators 140 to the ink introduction hole 116 can be prevented.

Therefore, when the vibrations are transmitted to the neighboring ink chambers in the related art, an unstable meniscus motion is observed, causing unstable droplet ejection and serving as noise in the eigenfrequency of an actuator of an adjacent ink chamber, thereby deteriorating printing quality.

However, in this embodiment, the air traps 150 prevent the transmission of the vibration, thereby increasing printing quality.

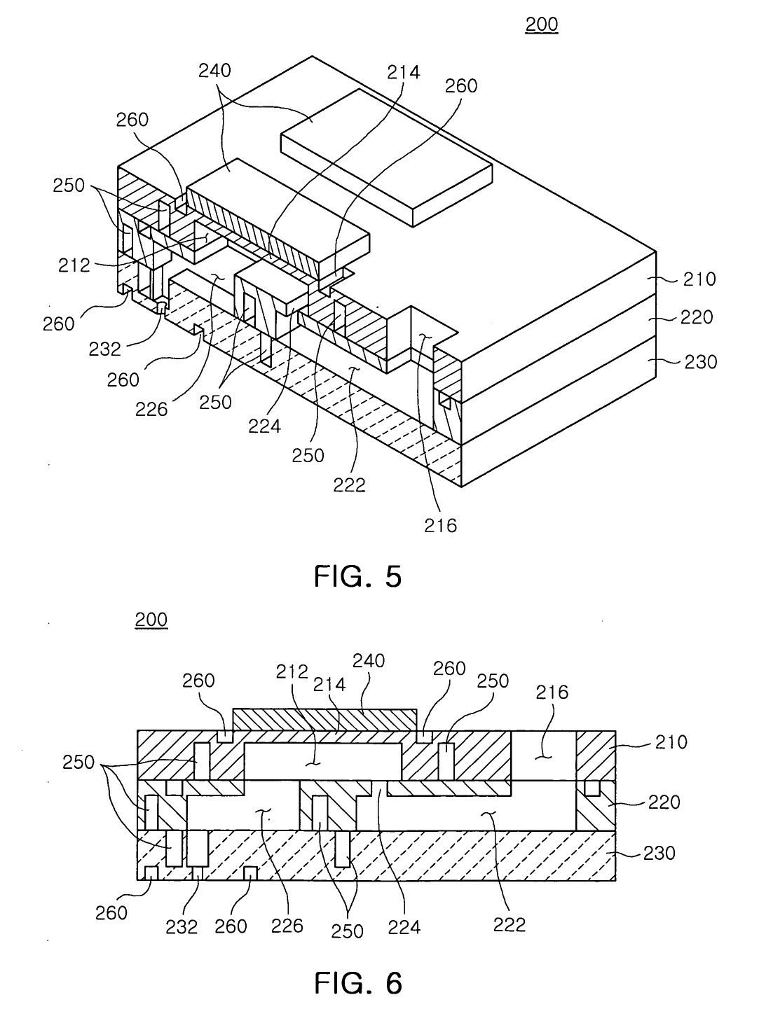

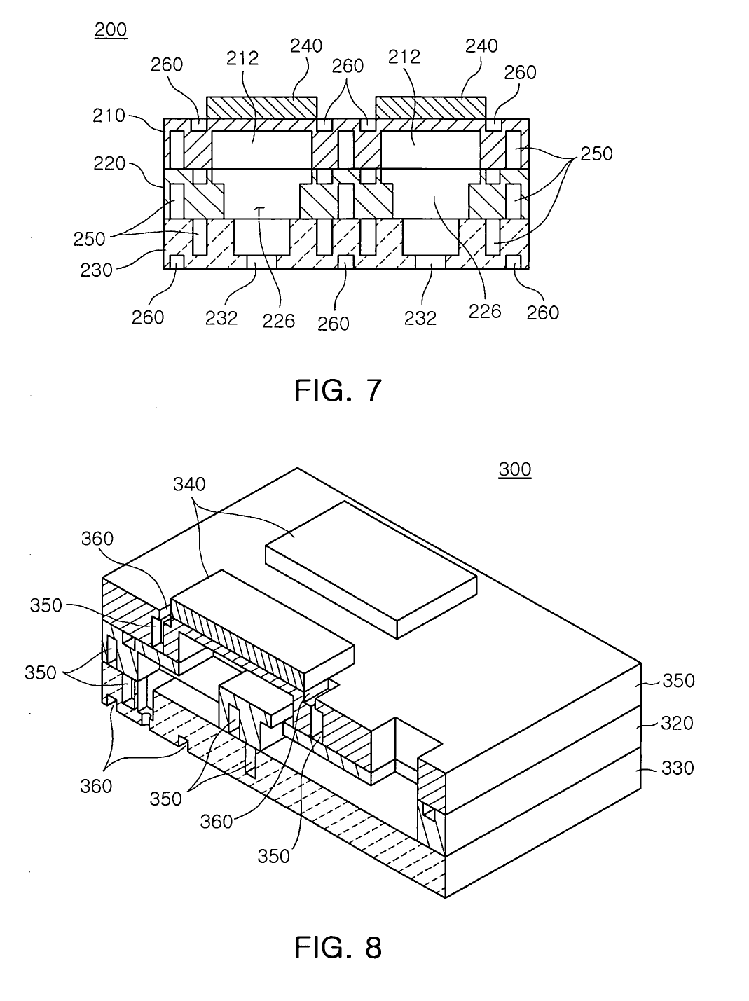

FIG. 5 is a schematic perspective view illustrating an inkjet head according to another exemplary embodiment of the invention. FIG. 6 is a cross-sectional view illustrating the inkjet head of FIG. 5. FIG. 7 is a side sectional view illustrating the inkjet head of FIG. 5.

Referring to FIGS. 5 through 7, an inkjet head 200 may have a flow path plate 210, an intermediate plate 220, a nozzle plate 230, air traps 250 and open recesses 260.

In this embodiment, the configurations of the flow path plate 210, the intermediate plate 220 and the nozzle plate 230 and a method of manufacturing the same are substantially the same as those of the embodiment described with reference to FIGS. 1 through 4.

Ink chambers 212 of the flow path plate 210, a vibration plate 214, a manifold 222 of the intermediate plate 220, a restrictor 224, dampers 226, and nozzles 232 of the nozzle plate 230 are the same as those of the embodiment, described with reference to FIGS. 1 through 4. Thus, a detailed description thereof will be omitted.

The air traps 250 are formed between one ink chamber 212 and its adjacent ink chamber 212. The air traps 250 may also be formed between the ink chambers 212 and ink introduction hole 216 and between the dampers 226 and the manifold 222. However, the locations of the air traps 250 are not limited thereto, and may be formed at various positions according to the designers' intentions.

Therefore, in this embodiment, the air traps 250 can prevent the transmission of vibrations caused by piezoelectric actuators 240 to the ink introduction hole 216, the manifold 222 or the nozzles 232.

Here, the plurality of air traps 250 are not manufactured separately. Recesses are formed by an etching process together with other structures, and the flow path plate 210, the intermediate plate 220 and the nozzle plate 230 are bonded to each other to thereby form the air traps 250.

In addition, the air traps 250 may be formed between the ink chambers 212 and the ink introduction hole 216 through which ink is introduced. Therefore, in this embodiment, the air traps 250 prevent the transmission of vibrations to the other components, thereby increasing printing quality.

The open recesses 260 are formed in the surface of the flow path plate 210. Here, the open recesses 260 may be formed at positions adjacent to positions at which the piezoelectric actuators 240 are mounted. Therefore, in this embodiment, since the open recesses 260 guide the positions at which the piezoelectric actuators 240 are disposed, the mounting process can be facilitated.

Furthermore, in this embodiment, the open recesses 260 formed around the piezoelectric actuators 240 allow the vibrations caused by the piezoelectric actuators 240 to be transmitted to the ink chambers 212 rather than to the outside, thereby increasing the efficiency thereof. Here, the open recesses 260 may be formed around the nozzles 232, the positions of the open recesses 260 are not limited thereto.

FIG. 8 is a schematic perspective view illustrating an inkjet head according to another exemplary embodiment of the invention.

Referring to FIG. 8, an inkjet head 300 may include a flow path plate 310, an intermediate plate 320, a nozzle plate 330, air traps 350 and open recesses 360.

The configurations of the flow path plate 310, the intermediate plate 320 and the nozzle plate 330 according to this embodiment are substantially the same as those of the embodiment, described with reference to FIGS. 1 through 4. Thus, a detailed description thereof will be omitted.

The air traps 350 and the open recesses 360 according to this embodiment are substantially the same as those of the embodiment, described with reference to FIGS. 5 through 7. A detailed description thereof will therefore be omitted.

In this embodiment, the air traps 350 and the open recesses 360 are partially connected to each other, whereby the air traps 350 and the open recesses 360 may form one flow path.

Therefore, air generated when the individual plates are bonded to each other is automatically moved into the space of the air traps 350. Since the air traps 350 and the open recesses 360 are connected to form a single flow path, the generated air can be discharged outside the inkjet head. Therefore, bonding failures caused by tapped air can be prevented.

As set forth above, since an inkjet head and a method of manufacturing the same according to exemplary embodiments of the invention form air traps inside a flow path plate and a nozzle plate, the air traps prevent the transmission of vibrations caused by actuators to another adjacent chamber, thereby preventing crosstalk affecting another chamber.

Furthermore, according to the inkjet head and the method of manufacturing the same, since open recesses are formed in at least one of a flow path plate and a nozzle plate, positions at which actuators are mounted can be easily determined, and the transmission of the vibrations of the actuators in a horizontal direction can be prevented so that the vibrations can be effectively transmitted to ink chambers.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
a flow path plate having a plurality of ink chambers therein;
a nozzle plate having a plurality of nozzles connected to the ink chambers in order to eject ink in the ink chambers to the outside; and
air traps provided inside the flow path plate and the nozzle plate to prevent crosstalk in which vibrations for driving the ink chambers affect another adjacent ink chamber.

2. The inkjet head of claim 1, wherein open recesses are provided in at least one of the flow path plate and the nozzle plate.

3. The inkjet head of claim 2, wherein the open recesses and the air traps are connected to each other.

4. The inkjet head of claim 2, wherein the open recesses are provided in both ends of actuators provided on an upper surface of the flow path plate and corresponding to the ink chambers.

5. The inkjet head of claim 1, wherein the air traps are provided between one of the ink chambers and another ink chamber adjacent thereto.

6. The inkjet head of claim 1, wherein the air traps are provided between the ink chambers and an ink introduction hole through which ink is introduced.

7. The inkjet head of claim 1, wherein the air traps are provided between dampers ejecting the ink in the ink chamber through the nozzles and a manifold supplying ink to the ink chambers.

8. A method of manufacturing an inkjet head, the method comprising:
providing a flow path plate and a nozzle plate;
forming a plurality of recesses in one surface of the flow path plate and one surface of the nozzle plate making contact with each other; and
forming air traps inside the flow path plate and the nozzle plate by bonding the flow path plate and the nozzle plate with the plurality of recesses.

9. The method of claim 8, wherein the forming of the plurality of recesses comprises forming open recesses in a surface of the flow path plate.

10. The method of claim 9, wherein the plurality of recesses and the open recesses are connected to each other.

11. The method of claim 8, wherein the plurality of recesses are formed at the same time by an etching process.

12. The method of claim 8, wherein a multi-stage damper is formed in the nozzle plate.
